(19) United States
(12) Patent Application Publication
(10) Pub. No.: US 2005/0084762 A1
(43) Pub. Date: Apr. 21, 2005

(54) Hybrid gelled-electrolyte valve-regulated lead-acid battery

(76) Inventors: Frank J. Vaccaro, Parisppany, NJ (US); Thomas Denis O'Sullivan, Summit, NJ (US); Bich Le, Hamburg, NJ (US)

Correspondence Address: DEMONT & BREYER, LLC, SUITE 250, 100 COMMONS WAY, HOLMDEL, NJ, 07733, US

(21) Appl. No.: 10/685,721

(22) Filed: Oct. 15, 2003

(51) Int. Cl. H01M 10/10; H01M 10/04

(52) U.S. Cl. 429/302; 29/623.1; 429/204

(57) ABSTRACT

A hybrid gelled-electrolyte VRLA battery and method for its manufacture are disclosed. In accordance with the present invention, the VRLA battery includes both an AGM separator and a first gelled electrolyte. In accordance with the method, a first silica-electrolyte mixture is placed in contact with the battery plates and AGM separator before formation. During plate formation, the mixture gels to form the first gelled electrolyte. In some embodiments, after forming the plates, a smaller amount of a second gelled electrolyte is added to the battery jar.

### FIELD OF THE INVENTION

The present invention relates generally to batteries, and more particularly to valve-regulated lead-acid batteries.

### BACKGROUND

The basic materials in lead-oxide battery production are lead alloys to make the plates and lead oxide for the active material. The electrochemical reactions that occur within a lead-acid battery involve lead, lead dioxide, an aqueous solution of sulfuric acid. The electrode reactions are:
For the positive electrode:

$$\begin{matrix}{PbO}_{2} + {HSO}_{4}^{-} + 3 {H}^{+} + 2 {e}^{-} {{↔}^{( ← discharge )}}_{( charge \to )} {PbSO}_{4} + 2 {H}_{2} O \\ For the negative electrode \text{:} & [ 1 ] \\ Pb + {HSO}_{4}^{-} {{↔}^{( ← discharge )}}_{( charge \to )} {PbSO}_{4} + {H}^{+} + 2 {e}^{-} \\ The overall cell reaction \text{:} & [ 2 ] \\ {PbO}_{2} + Pb + 2 {H}_{2} {SO}_{4}^{-} + 2 {H}^{+} {{↔}^{( ← discharge )}}_{( charge \to )} 2 {PbSO}_{4} + 2 {H}_{2} O & [ 3 ]\end{matrix}$$

In a lead-acid battery, during the final stage of the charging cycle, or under overcharge, the charging energy is consumed for electrolytic decomposition of water. Oxygen gas is generated at the positive plate and hydrogen gas is generated at the negative plate. The rates of oxygen and hydrogen evolution depend upon which of two types of lead-acid batteries—flooded-cell or sealed immobilized-electrolyte—is host to the reactions.

The flooded-cell battery is characterized by an excess of electrolyte that floods the battery cell, completely saturating the plates with free liquid electrolyte. In this type of battery, oxygen and hydrogen gas are not efficiently recombined. Rather, relatively large volumes of these gases are allowed to bubble to the top of the battery where they pass through a vent to the outside environment. To account for this loss of oxygen and hydrogen, water must be periodically added to the battery.

The sealed immobilized-electrolyte battery, which is also known as a recombination battery or valve-regulated lead acid (“VRLA”) battery (these terms will be used interchangeably herein), operates in a starved condition with a deficit of electrolyte. In this type of battery, the electrolyte is not free; rather, it is immobilized in some fashion, as described further below.

In the VRLA battery, most of the gases are recombined rather than vented. In further detail, oxygen that is generated at the positive plate via reaction [4] migrates to the negative plate. Oxygen migration is promoted by certain physical adaptations of the VRLA battery, as described below.
2H₂O-→O₂+4H⁺+2e⁻ [4]
At the negative plate, the oxygen gas reacts with a moist, negative, active material, often referred to as “spongy” lead (i.e., a paste of lead powder and additives such as carbon, barium sulfate, lignin, etc.) to form lead oxide, as per reaction [5].
2Pb+O₂→2PbO [5]
This oxidation causes a slight depolarization and inhibits the release of hydrogen gas. The lead oxide at the negative plate (formed via reaction [5]) reacts to form lead sulphate and water is reformed according to reaction [6].
2PbO+2H₂SO₄→2PbSO₄+2H₂O [6]
The water that is reformed in reaction [6] drives reaction [4]. On further charge, the lead sulfate that is formed in reaction [6] is reacted to form lead and sulphuric acid, as per reaction [7].
2PbSO₄+4H⁺+2e⁻→2Pb+2 H₂SO₄ [7]
The net reaction at the negative plate is:
O₂+4H⁺+4e⁻→2H₂O [8]
In this fashion, the migration and recombination of oxygen suppresses the formation of hydrogen gas. Since there is only minor net loss of hydrogen or oxygen, there is no need to add water.

As indicated above, the electrolyte in a VRLA battery is immobilized by some means. In practice, electrolyte immobilization is accomplished in either of two ways.

One way to immobilize the electrolyte is to use a fibrous mat separator. A separator for separating the positive and negative plates is, of course, present in all such batteries to prevent shorts. Unlike flooded-cell separators, the fibrous mat separator is at least 90% percent porous so that it absorbs much of the electrolyte that is added to the battery cell. The most common fibrous mat separator is an absorbent glass mat, typically referred to as an AGM separator. The AGM separator is highly porous and absorbent, and has very low electrical resistance. The AGM separator is maintained under compression between the plates to assure contact with the surface of the plates so that the electrolyte is available for the various electrochemical reactions.

Although soaked with electrolyte, the AGM separator maintains a small amount of void space that is free of electrolyte. This void space supports migration of the oxygen gas (i.e., formed via reaction [4]) to the negative plate. The void space in the AGM separator is one of the physical adaptations alluded to above that promotes oxygen migration.

The other method for immobilizing electrolyte is to create a gel, that is, a gelled electrolyte. The gelled electrolyte is formed by adding a gelling agent, such as silica, to the electrolyte. The standard gelled-electrolyte VRLA battery typically uses a robust, micro-porous leaf separator that is made of plastic, glass or rubber. This type of separator, which is less porous than the AGM separator, is mainly relied upon to separate the plates to avoid shorts.

In the gelled-electrolyte battery, the cells are filled to the top of the plates with gelled electrolyte. Channels, fissures, etc., form in the gel between the plates. The channels are believed to form as a consequence of an initial water loss due to electrolysis. The channels support migration of oxygen to promote the recombination reaction.

A further adaptation that promotes gas recombination is a mechanical valve that seals the battery cell. The valve prevents oxygen from escaping from the cell, thereby increasing the chances for recombination. The valve also functions to regulate the pressure of the battery cell at a desired level. This, in fact, is the genesis of term “valve-regulated” (lead-acid battery).

Both AGM-based and gelled-electrolyte-based VRLA batteries (hereinafter simply “AGM-separator-equipped batteries” and “gelled-electrolyte batteries”) have certain characteristic drawbacks.

As to the drawbacks of gelled-electrolyte batteries:
Gelled-electrolyte batteries provides somewhat less long-duration capacity than an AGM-separator-equipped battery for a given container volume. One reason for this is that gelled electrolyte batteries usually have higher internal electrical resistance than AGM-separator-equipped batteries due to the relatively high electrical resistance of the micro-porous leaf separator of the gelled-electrolyte battery.
Gelled-electrolyte batteries attain lower terminal voltage and shorter run times at high discharge rates. This is due, again, to the relatively higher internal electrical resistance of gelled-electrolyte batteries.
Gelled-electrolyte batteries generally exhibit lower oxygen recombination efficiency and higher water loss than AGM-separator-equipped batteries. This is primarily due to the relatively low-porosity leaf separators used in most gelled-electrolyte batteries.

As to the drawbacks of AGM-separator-equipped batteries:
AGM-separator-equipped batteries are more susceptible to thermal problems than gelled-electrolyte batteries. This susceptibility arises for several reasons. One reason is that a gelled-electrolyte battery contains more electrolyte than AGM-separator-equipped batteries, so that the gelled-electrolyte battery contains a greater heat sink. Also, due to its normally more efficient oxygen recombination cycle and lower internal resistance, the AGM-separator-equipped battery draws more float current. This results in greater internal heat generation. Furthermore, while the gelled-electrolyte battery has gel in full contact with the plates (where heat is generated) and with the walls of battery container (where heat is removed), in the AGM-separator-equipped battery, the electrolyte is not in complete contact with the walls of the container. The gelled-electrolyte battery therefore generates less heat and provides substantially better heat dissipation than the AGM-separator-equipped battery.
AGM-separator-equipped batteries have a relatively shorter cycle life caused by stratification of electrolyte. It has been observed that there is a decrease, over time, in the concentration of sulfate ion (i.e., SO₄⁻²) near the top of the battery cell. This has been shown to be the result of the recharging cycle wherein sulfate ion leaving the plates migrates to the bottom of the cell. As this migration occurs, battery capacity decreases to the point where the battery must be replaced.

In an attempt to address the stratification problem that occurs in AGM-separator-equipped batteries, a re-positioning method was adopted. According to this method, the battery is turned “sideways” so that its plates are oriented horizontally, as in a stack of pancakes, rather than in the typical vertical orientation. This method, known as “pancaking,” substantially prevents electrolyte stratification and has proven to be quite effective in recovering battery capacity (after it declines due to stratification) thereby extending the cycle life of a battery. See, e.g., Vaccaro et al., “VRLA Battery Capacity Cycling: Influences of Physical Design, Materials, and Methods to Evaluate their effect,” IEEE, (1998).

Unfortunately, “pancaking” a battery, as described above, can be problematic. In particular, the footprint of a pancaked battery prohibits its use in some existing locations.

In another attempt at addressing the problem of electrolyte stratification, a separator with smaller average pore diameter was developed and tested. While initial results were positive, this approach did not ultimately yield sufficient performance improvements.

In view of the foregoing, it will be appreciated that the two types of immobilized electrolyte batteries have certain characteristic drawbacks that limit their applicability. As indicated above, the AGM-separator-equipped battery is subject to thermal problems and acid stratification, while the gelled-electrolyte battery is handicapped by relatively poorer long-duration capacity, lower terminal voltage, and shorter run times at high discharge rates than an AGM-separator-equipped battery. A need therefore remains for an improved VRLA battery that provides the following attributes, in addition to any others:
Decreased likelihood of acid stratification;
Acceptable thermal stability; and
Good high-rate discharge performance.

### SUMMARY

The illustrative embodiment of the present invention is a hybrid VRLA battery, and a method for its manufacture, that provides a decreased likelihood of acid stratification, acceptable thermal stability and good high-rate discharge performance.

Unlike prior-art VRLA batteries, and in accordance with the illustrative hybrid VRLA battery and methods, colloidal silica is added to an AGM-separator-equipped battery before the (negative and positive) plates are formed. Colloidal silica has a very small particle size—typically 10 to 20 nanometers—that enables it to enter the battery plates and the mesh of the AGM separator. As the acid concentration increases during plate formation, the silica/electrolyte mix begins to gel. Since the silica/electrolyte mix is present within the battery plates and the AGM separator, the gelled electrolyte will form in those locations. This is in contrast to prior-art gelled-electrolyte batteries, wherein the gelled electrolyte is not present in the leaf separator or the battery plates. And this is in contrast to prior art AGM-separator equipped batteries, which generally do not incorporate a gelled electrolyte. To the extent that AGM-separator equipped batteries do incorporate a gelled electrolyte, none have gelled electrolyte within the AGM-separator and plates.

The presence of silica-gelled electrolyte in the AGM-separator and plates of the hybrid batteries and methods disclosed herein provides a number of benefits that are not found in a prior-art AGM-separator-equipped battery or a prior-art gelled-electrolyte battery:
The gelled electrolyte in the AGM-separator and battery plates tends to retain the sulfate ion that leaves the plates on recharge, thereby preventing or substantially reducing acid stratification. This extends battery cycle life relative to a prior art AGM-separator-equipped battery.
The batteries and methods described herein provide improved oxygen recombination efficiency and, therefore, better water conservation. Earlier gelled electrolyte/leaf separator batteries use relatively low porosity, leaf separators. These types of separators are more resistant to oxygen diffusion and hence exhibit greater water loss.
No costly dumping of formation electrolyte. In the prior art, the electrolyte that is used to form the plates is dumped at the completion of plate formation (when the plates are being formed in the actual battery container or “jar”). In the hybrid VRLA batteries and method disclosed herein, the formation electrolyte is gelled so there is no need to pour off electrolyte.

In some embodiments, after forming the plates in the presence of a first silica-electrolyte mixture (which gels to form a first gelled electrolyte), a smaller amount of a second silica-electrolyte mixture (which immediately gels to form a second gelled electrolyte) is added to fill any remaining void volume in the cell. The use of two gelled electrolytes in this fashion results in a longer discharge cycle life, additional heat sinking for improved thermal stability, and a larger electrolyte reserve than could otherwise be provided.

### BRIEF DESCRIPTION OF THE DRAWINGS

FIG. 1 depicts a typical VRLA battery.

FIG. 2 depicts a method for forming a VRLA battery in accordance with the illustrative embodiment of the present invention.

FIG. 3 depicts a cell of a VRLA battery in accordance with the illustrative embodiment of the present invention. In this Figure, a first silica-electrolyte mixture that was added prior to plate formation has gelled (during and after formation) to form a first gelled electrolyte.

FIG. 4 depicts the cell depicted in FIG. 3 after a second gelled electrolyte is added.

FIG. 5 depicts battery capacity as a function of silica concentration in the first silica-electrolyte mixture.

FIG. 6 depicts comparative testing of four batteries by way of plots of capacity versus cycle number.

### DETAILED DESCRIPTION

The following terms are defined for use in this Description and in the Claims:

Cell means a single electrochemical unit having at least one positive plate, one negative plate, and a separator material disposed between those plates. The cell is contained within a plastic housing and nominally provides 2.0 volts potential.

Battery means a plurality of electrically-coupled cells that provide a specified voltage and a specified current over a specified time.

Capacity means the electrical energy content of a battery, typically expressed as ampere-hours. The energy is measured by observing the time to discharge a battery at a constant current until a specified cut-off voltage is reached.

Cycle means a process consisting of a single charge and a single discharge of a rechargeable battery.

Cycle life means the number of cycles a battery provides before it is no longer usable, due to a decline in capacity (usually to a value in the range of about 60 to 80 percent of initial capacity).

Electrolyte means an acid solution for ionic conduction of electricity between the positive and negative plates of a battery.

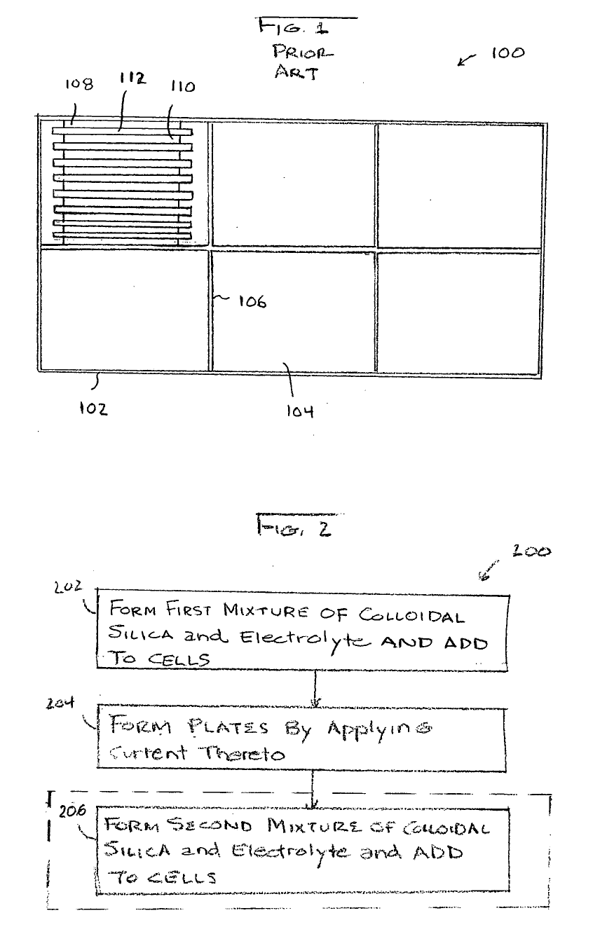

FIG. 1 depicts a schematic of a known VRLA battery 100. The battery includes housing or “jar” 102, which includes a plurality of electrochemical cells 104. Typically, six cells 104 are included in such a battery, as is depicted in FIG. 1. Cells 104 are segregated by internal partitions 106.

Each cell 104 includes a plurality of alternating, spaced, positive lead metal plates 108 and negative lead metal plates 110. Adjacent positive and negative lead plates are separated by separator 112. Within each cell 104, plates 108 and 110 are typically connected in parallel (i.e., positive plate to positive plate and negative plate to negative plate) using bus bars, etc. (not shown). Cells 104 are usually connected to one another (e.g., by joining the bus bars, etc.) in series (i.e., negative to positive and positive to negative). Since each cell nominally generates about 2 volts, six cells in series nominally generate about 12 volts.

As discussed in the Background section, there are two basic implementations of a VRLA battery in art: those that use a liquid electrolyte in conjunction with an absorbent glass mat (“AGM”) separator or those that use a gelled electrolyte and a robust plastic or glass leaf-type (non-fibrous) separator.

To create the former type of battery, plates 108, 110 and AGM separator are placed in jar 102 (or other container). Electrolyte comprising dilute sulfuric acid is added to the jar. The electrolyte has a particular specific gravity (e.g., about 1.25, etc.) as a function of the desired rate of battery discharge, desired battery float voltage, and the intended use of the battery. Electrical current is then applied to the battery to “form” the plates.

Formation is a well-known process that converts the chemicals in the plates to potential electrical energy. More particularly, under normal ambient conditions and as a function of pH, lead oxide or one of the lead sulfates (i.e., basic, tribasic, or tetrabasic) are the most favored compounds (on the plates). But the final active materials in the lead-acid battery—lead dioxide and metallic lead—are at a higher energy level. In order to form these compounds, energy must be added. Energy addition occurs during a normal charge in the form of electrical energy.

The reaction that occurs at the positive plate during formation is:
2PbSO₄+2H₂O→PbO₂+H₂SO₄+2e⁻+2H⁺
The reaction that occurs at the negative plate during formation is:
PbSO₄+2e⁻+2H⁺→Pb+H₂SO₄

To create a prior-art, gelled-electrolyte VRLA battery, one of several methods can be used. In one method, plates 108, 110 and leaf separator are placed in jar 102. Liquid electrolyte is added to jar 102 and a mild charging is conducted. The battery is then discharged, and the liquid electrolyte is removed. A mixture of fumed silica and a dilute sulfuric-acid electrolyte is created and added to the battery. The silica/electrolyte mix gels when the battery is recharged and the acid concentration increases.

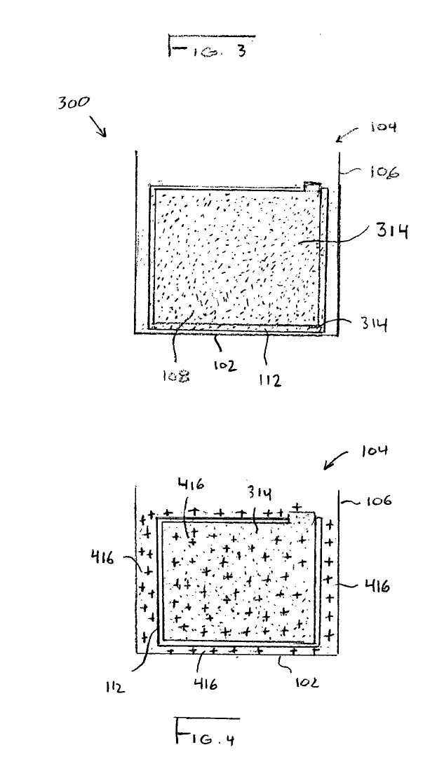

FIG. 2 depicts method 200 for manufacturing a VRLA battery in accordance with the illustrative embodiment of the present invention. Batteries made in accordance with this disclosure have some of the same elements as battery 100 depicted in FIG. 1. That is, the battery includes jar 102, a plurality of cells 104, positive plates 108, negative plates 110, and separator 112. In some embodiments, a VRLA battery in accordance with the present teachings includes an AGM separator as separator 112 and one or two gelled electrolytes. AGM separator 112 has a porosity of at least 90 percent and is formed from glass, or a mixture of glass and plastic fibers.

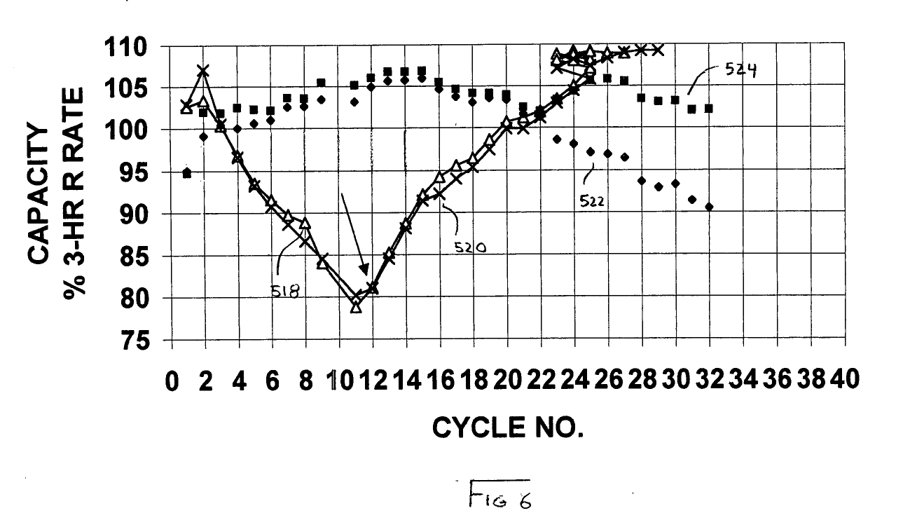

In accordance with operation 202 of method 200, a mixture of:
(1) aqueous colloidal silica; and
(2) sulfuric acid electrolyte
   is created and then added to the cells of the nascent battery. In this mixture, referred to herein as “first silica-electrolyte mixture,” silica as SiO₂ is within a range of about 1.0 percent to 8.0 percent by weight (of the first silica-electrolyte mixture). More preferably, silica as SiO₂ is within a range of about 2.0 percent to 5.0 percent by weight of the first silica-electrolyte mixture. And, most preferably, silica as SiO₂ is within a range of 2.5 percent to 3.5 percent by weight of the first silica-electrolyte mixture. For the most preferred range of silica, battery capacity will be in the range of about 99 to 97 percent. If a lower concentration of silica is used, battery capacity increases and if a higher concentration of silica is used, battery capacity decreases, in accordance with the relation depicted in FIG. 5. The range of 2.5 to 3.5 percent was selected because it provides a more dense gel to better prevent stratification of electrolyte and delivers satisfactory performance.

The aqueous colloidal silica that is used for the first silica-electrolyte mixture comprises SiO₂ in an amount between about 10 percent to 50 percent by weight (and water). The aqueous colloidal silica can also include stabilizers. In some embodiments, 40 percent by weight colloidal silica, commercially available from EKA Chemicals of Marietta, Ga. or others is used. Colloidal silica is used in preference to other types of silica (.e.g., fumed silica, etc.) because it includes particularly small silica particles, typically in the range of about 10 to 20 nanometers. These small particles are more readily absorbed into the plates and AGM separator than the larger particles of silica, such as are found in fumed silica. In some other embodiments, other silica preparations having very small silica particles less than about 100 nanometers can suitably be used. One such alternative preparation is precipitated silica.

The electrolyte in the first silica-electrolyte mixture comprises dilute sulfuric acid. Electrolyte strength is generally characterized by specific gravity, since this is directly correlated to concentration. The concentration of the sulfuric acid electrolyte to which the silica is added is selected so that at the completion of plate formation and gelling of the first silica-electrolyte mixture (to form the “first gelled electrolyte”), the specific gravity of the first gelled electrolyte is at a desired value. That desired value is a function of the desired rate of battery discharge, desired battery float voltage, and the intended use of the battery. Typically, the desired specific gravity of the gelled electrolyte after plate formation will be in a range of about 1.28 to 1.31. To achieve this, the specific gravity of the sulfuric acid (before mixing) will be in a range of about 1.20 to 1.25.

In some embodiments, the first silica-electrolyte mixture is added to the cells under a reduced pressure in a range about −0.6 to about −1.0 atmospheres. The reduced pressure removes trapped air from the plates and AGM separator and also promotes absorption of the silica into the plates and AGM separator.

Current is applied to the plates to carry out the “formation” process in accordance with operation 204. This process is well known in the art and conducted in the usual fashion. As is known in the art, formation can be carried out as a step function of the applied current to prevent excessive internal heating. Alternatively, formation can be conducted with the battery in a water bath to control the temperature increase.

FIG. 3 depicts a side view of a cell 104 of battery 300 in accordance with the illustrative embodiment of the present invention. Cell 104 includes at least one positive plate 108, at least one AGM separator 112, at least one negative plate (not shown), and first gelled electrolyte 314. As previously indicated, the first silica-electrolyte mixture is added before plate formation. During plate formation, the specific gravity of first silica-electrolyte mixture increases as residual sulfate from the paste (see, paragraph [0006]) enters the electrolyte. As the specific gravity increases, the first silica-electrolyte mixture begins to gel. The gelling time is a function of silica content and electrolyte specific gravity. The first silica-electrolyte mixture is usually fully gelled, forming first gelled electrolyte 314, shortly after plate formation is complete. Little or none of first gelled electrolyte 314 is present outside of plates 108 and 110, and AGM separator 112; most of gelled electrolyte 314 is absorbed by those components.

After plate formation, in optional operation 206, a second silica-electrolyte mixture is prepared and added to the cells. In some embodiments, the second silica-electrolyte mixture comprises the same constituents as the first silica-electrolyte mixture; namely, colloidal silica and sulfuric acid electrolyte.

The concentration of the sulfuric-acid electrolyte (to which the silica is added to create the second silica-electrolyte mixture) is selected so that the specific gravity of the second gelled electrolyte (which is formed from the second silica-electrolyte mixture) is at the desired value described above (i.e., typically 1.28 to 1.31). In the second silica-electrolyte, silica can be present in any amount that is sufficient to maintain a gel consistency. Typically, silica as SiO₂ will be in a range of about 10-19 percent by weight (of the second silica-electrolyte mixture).

At high concentrations of silica such as will be used to form the second silica-electrolyte mixture, a mixture of silica and sulfuric-acid electrolyte will gel immediately. Consequently, when the second silica-electrolyte mixture contains about 8 percent by weight or more of silica, a dynamic mixer is used to rapidly mix and substantially immediately deliver the rapidly gelling second silica-electrolyte mixture to the appropriate cells in a battery. Dynamic mixtures are well known in the art and are commonly used, for example, for blending two-part epoxies. In this case, the colloidal silica and the sulfuric acid are independently added to an in-line vortex mixer. The mixer mixes the silica and acid within seconds and immediately dispenses the mixture, which has already begun gelling, to the required battery location.

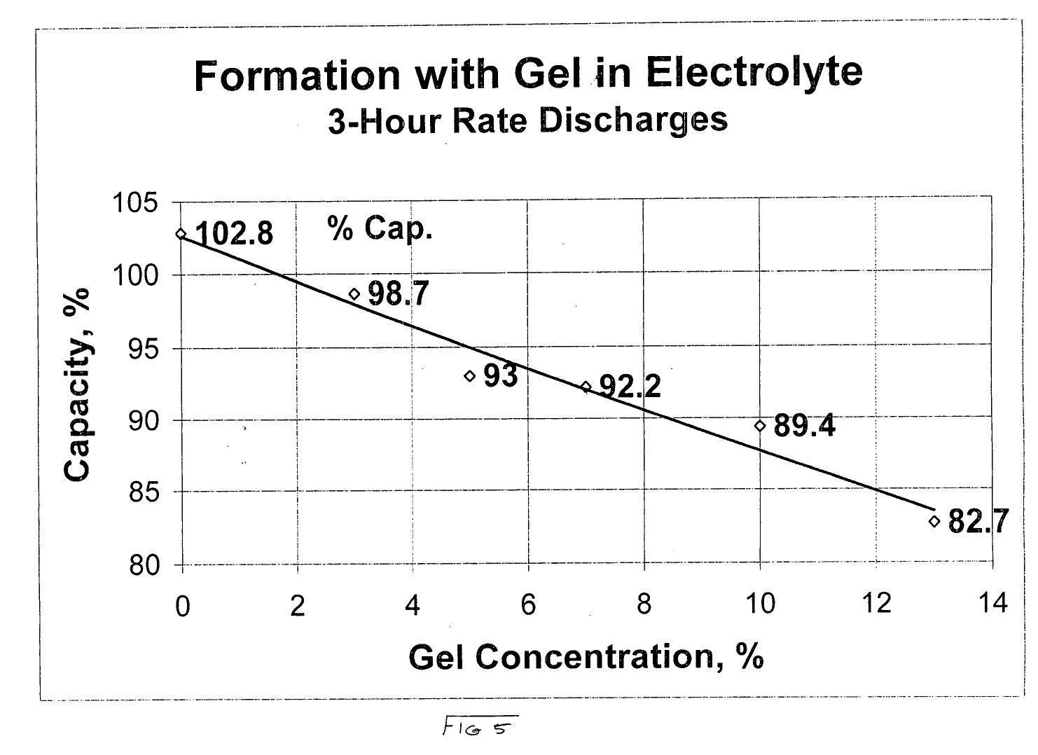

Since adding silica to sulfuric acid generates heat, the colloidal silica and sulfuric acid electrolyte is advantageously cooled (e.g., to about 5 degrees centigrade, etc.) before mixing. FIG. 4. depicts a side view of cell 104 of battery 300 of FIG. 3 after second gelled electrolyte 416 is added. As previously indicated, second gelled electrolyte 416 is added after plate formation.

After the second gelled electrolyte is added to jar 102, the cells are sealed with pressure relief valves.

The first gelled electrolyte is added in an amount that is sufficient to substantially fill jar 102 (e.g., to the top of plates 108 and 110). The second gelled electrolyte is added in a substantially smaller quantity to the top of the plates and is allowed to flow down the plate sides. Typically, the ratio of the volume of the first gelled electrolyte to the volume of the second gelled electrolyte is within a range of about 15:1 to 40:1, and more preferably within a range of about 24:1 to 32:1.

An example of a-battery that was made in accordance with the illustrative embodiment of the present invention follows. This example is provided by way of illustration, not limitation.

### EXAMPLE

A 12 volt-100 Ah battery was prepared in accordance with the illustrative embodiment of the present invention as follows. An alternating arrangement of positive plates and negative plates was assembled. An AGM separator was disposed between adjacent plates. AGM separator model 067 was obtained from Hollingsworth & Vose Company of East Walpole, Mass. The arrangement of plates and AGM separators was placed in a battery jar having dimensions 12½ inches long×6½ inches wide×8½ inches deep.

A first silica-electrolyte mixture comprising aqueous colloidal silica and dilute sulfuric acid was prepared and added to the jar. The colloidal silica was obtained from EKA Chemicals as a 40 percent mixture. The dilute sulfuric acid had a specific gravity of 1.232 before mixing and a specific gravity of 1.220 after mixing. Silica in the first gelled electrolyte as SiO₂ was 3.0 percent. 800 cc of the first silica-electrolyte mixture was added to each of six cells in the jar (i.e., total of 4800 cc).

The plates were then formed by applying 10 amps. The specific gravity of the first gelled electrolyte was 1.30 after formation.

A second silica-electrolyte mixture comprising aqueous colloidal silica and dilute sulfuric acid was prepared and added to the jar. The dilute sulfuric acid had a specific gravity of 1.50 before mixing and a specific gravity of 1.30 after mixing. Silica in the second silica-electrolyte mixture as SiO₂ was 17.0 percent by weight. 150-200 cc of the second gelled electrolyte was added to the jar to cover the top of the plates.

FIG. 6 depicts comparative testing of four batteries by way of plots of capacity versus cycle number. Plots 618 and 620 depict the results for two AGM-separator-equipped VRLA batteries having no silica in the electrolyte. As plots 618 and 620 depict, with no silica in the electrolyte, battery capacity plummets to 80 percent in about 11 cycles. For the twelfth cycle, these batteries were “pancaked” (i.e., re-oriented to a horizontal position) and their performance recovered as expected.

Plot 622 depicts the performance of an AGM-separator-equipped VRLA battery wherein the plates were formed in the presence of a silica-electrolyte mixture, but with an amount of silica (5 wt. percent) that is outside of the preferred range (2.5 wt. percent<silica<3.5 wt. percent). Plot 622 shows that for this battery, performance is stable or improving for about 15 cycles, then declines steadily.

Plot 624 depicts the performance of an AGM-separator-equipped VRLA battery wherein the plates were formed with a silica-electrolyte mixture and the amount of silica (3.0 wt. percent) in the mixture is within the preferred range. As plot 624 depicts, performance is stable through 32 cycles, at which time the test was terminated.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

1. A method for manufacturing a battery having plates and an AGM separator, comprising:
mixing (i) silica and (ii) an electrolyte containing sulfuric acid to form a first silica-electrolyte mixture, wherein silica as SiO₂ is in a range of about 1.0 percent to about 8.0 percent by weight of said first silica-electrolyte mixture, and further wherein a particle size of said silica is less than 100 nanometers;
contacting said first silica-electrolyte mixture with said plates and said AGM separator; and
forming said plates by applying current thereto, wherein during and after said plates are formed, said first silica-electrolyte mixture gels to form a first gelled electrolyte.

2. The method of claim 1 wherein silica as SiO₂ is in a range of about 2.5 percent to about 3.5 percent by weight of said first silica-electrolyte mixture.

3. The method of claim 1 wherein a concentration of said sulfuric acid is selected so that a specific gravity of said first gelled electrolyte is at a desired value, after plate formation, as a function of a voltage of said battery.

4. The method of claim 1 further comprising:
mixing (i) silica and (ii) an electrolyte containing sulfuric acid to form a second silica-electrolyte mixture, wherein silica as SiO₂ is in a range of about 10 percent to about 19 percent by weight of said second silica-electrolyte mixture, and wherein said second silica-electrolyte mixture rapidly gels to form a second gelled electrolyte; and further wherein a concentration of said sulfuric acid is selected so that a specific gravity of said second gelled electrolyte is at said desired value; and
adding said second silica-electrolyte mixture to said battery after said plates are formed and in an amount sufficient to substantially fill any void volume remaining in said battery.

5. The method of claim 4 wherein a ratio of a volume of said first gelled electrolyte to a volume of said second gelled electrolyte is in a range of about 24:1 to 32:1.

6. A method for manufacturing a battery, comprising:
contacting an AGM separator and plates of said battery with a first silica-electrolyte mixture, wherein said first silica-electrolyte mixture comprises (i) colloidal silica and (ii) an electrolyte containing sulfuric acid, and wherein silica as SiO₂ is in a range of 1.0 percent to 8.0 percent by weight of said first silica-electrolyte mixture;
forming said plates by passing current therethrough; and
adding a second silica-electrolyte mixture to said battery after forming said plates, wherein said second silica-electrolyte mixture comprises (i) colloidal silica and (ii) an electrolyte containing sulfuric acid, and wherein silica as SiO₂ is in a range of about 10 percent to about 19 percent by weight of said second silica-electrolyte mixture.

7. The method of claim 6 wherein said first silica-electrolyte mixture gels to form a first gelled electrolyte during said forming of said plates, and wherein a specific gravity of said first gelled electrolyte is in a range of about 1.28 to 1.31, as a function of a desired voltage of said battery.

8. The method of claim 6 wherein a specific gravity of said second silica-electrolyte mixture is in a range of about 1.28 to 1.31.

9. The method of claim 6 wherein a ratio of a volume of said first silica-electrolyte mixture to a volume of said second silica-electrolyte mixture is in a range of about 24:1 to 32:1.

10. The method of claim 6 wherein forming said plates further comprises conducting plate formation at sub-atmospheric pressure.

11. The method of claim 1 wherein a particle size of said silica is in a range of about 10 to 20 nanometers.

12. The method of claim 1 wherein said silica as SiO₂ is in a range of about 2.5 percent to about 3.5 percent by weight of said first silica-electrolyte mixture.

13. A valve-regulated, lead-acid battery comprising:
a plurality of lead-acid cells, each cell comprising:
a plurality of spaced-apart positive plates, wherein said positive plates have a plurality of pores, and wherein at least some of said pores have a first gelled electrolyte adsorbed therein;
a plurality of spaced-apart negative plates arranged in alternating order with said positive plates, wherein said negative plates have a plurality of pores, and wherein at least some of said pores have said first gelled electrolyte adsorbed therein;
absorbent glass mat separator disposed between adjacent positive and negative plates, wherein said absorbent glass mat separator comprises a mesh and is at least about 90 percent porous, and wherein said mesh is substantially full of said first gelled electrolyte; and
a battery container, wherein said plurality of lead-acid cells are disposed in said battery container.

14. The battery of claim 13 wherein said first gelled electrolyte contains silica as SiO₂ and has a specific gravity that is within a range of about 1.28 to about 1.31.

15. The battery of claim 13 further comprising a gap between:
said positive plates and a wall of said battery;
said negative plates and said wall of said battery; and
said absorbent glass mat separator and said wall of said battery, wherein a second gelled electrolyte is disposed in said gap, wherein said second gelled electrolyte comprises silica as SiO₂, has a higher silica content than said first gelled electrolyte, and has a specific gravity that is within a range of about 1.28 to about 1.31.

16. The battery of claim 13 further comprising a space above said positive plates, said negative plates, and said absorbent glass mat separator, wherein a second gelled electrolyte is disposed in said space, wherein said second gelled electrolyte comprises silica as SiO₂, has a higher silica content than said first gelled electrolyte, and has a specific gravity that is within a range of about 1.28 to about 1.31.

17. A valve-regulated lead-acid battery comprising:
a plurality of lead-acid cells, each cell comprising:
a plurality of spaced-apart positive plates, wherein said positive plates comprise PbO₂ that is generated during a formation reaction that is conducted in the presence of a first silica-electrolyte mixture comprising silica and an electrolyte that contains sulfuric acid, wherein said silica as SiO₂ is in a range of about 1 percent to about 8 percent by weight of said first silica-electrolyte mixture;
a plurality of spaced-apart negative plates arranged in alternating order with said positive plates, wherein said negative plates comprise Pb that is generated during a formation reaction that is conducted in the presence of said first silica-electrolyte mixture;
absorbent glass mat separator disposed between adjacent positive and negative plates, said absorbent glass mat separator comprising a mesh; and
first gelled electrolyte that is formed from said first silica-electrolyte, wherein said first gelled electrolyte resides in pores of said positive plates, pores of said negative plates, the space between said positive and negative plates and in said mesh of said absorbent glass mat separator.

18. The battery of claim 17 further comprising:
a battery container having a plurality of physically-isolated compartments, wherein one lead-acid cell of said plurality thereof is disposed in each said compartment, and wherein said lead-acid cells are electrically connected to one another; and
a second gelled electrolyte, wherein said second gelled electrolyte is formed from a second silica-electrolyte mixture containing silica as SiO₂ in a range of about 10 percent to about 19 percent by weight of said second silica-electrolyte mixture, wherein said more of said first gelled electrolyte is present in said battery than said second gelled electrolyte.

19. The battery of claim 17 wherein silica as SiO₂ is in a range of 2.5 percent to 3.5 percent by weight of said first-electrolyte mixture, and wherein said first-electrolyte mixture comprises sulfuric acid, and further wherein a concentration of said sulfuric acid in said first-electrolyte mixture is selected so that a specific gravity of said first gelled electrolyte is at a desired value as a function of a voltage of said battery.

20. The battery of claim 18 wherein a ratio of a volume of said first gelled electrolyte to a volume of said second gelled electrolyte is in a range of about 24:1 to 32:1.
